(19) United States
(12) Patent Application Publication
(10) Pub. No.: US 2009/0224445 A1
(43) Pub. Date: Sep. 10, 2009

(54) Liquid Filled Type Vibration Isolator

(75) Inventors: Shingo Hatakeyama, Osaka (JP); Dai Ogasawara, Osaka (JP); Makoto Suzuki, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Toyo Tire & Rubber Co., Ltd., Osaka-shi, Osaka (JP)

(21) Appl. No.: 11/791,330

(22) PCT Filed: Nov. 17, 2006
(86) PCT No.: PCT/JP2006/322962

§ 371 Date: May 23, 2007

(30) Foreign Application Priority Data
Jan. 16, 2006 (JP) 2006-007249

(51) Int. Cl. F16F 13/18; F16F 13/06

(52) U.S. Cl. 267/140.12

(57) ABSTRACT

A liquid filled type vibration isolator which can reduce generation of abnormal noise without lowering vibration isolating capability includes a first attachment member 1, a second attachment member 2, a vibration isolating base 3, a diaphragm 9, a partitioning member 12, and an orifice 25. The partitioning member 12 has an annular orifice forming member 16 provided inside of the second attachment member, a rubber wall 15 bonded to an inner circumferential surface 16N of the orifice forming member 16 by vulcanization to close the inside of the inner circumferential surface 16N, and a pair of partitioning plates 17 and 18 between which the rubber wall is sandwiched in an axial direction G. The one partitioning plate 18 constitutes a part of a chamber wall of a first liquid chamber 11A, and the other partitioning plate 17 constitutes a part of a chamber wall of a second liquid chamber 11B. Displacements of the pair of the partitioning plates 17 and 18 in the axial direction G of the orifice forming member 16 are regulated by the rubber wall 15.

### TECHNICAL FIELD

The present invention relates to a liquid filled type vibration isolator.

### BACKGROUND ART

A known liquid filled type vibration isolator includes: a first attachment member, a cylindrical second attachment member, and a vibration isolating base made of rubber-like elastic material for connecting the first attachment member and the second attachment member; a diaphragm formed by a rubber film and attached to the second attachment member to provide a liquid filled chamber between the vibration isolating base and the diaphragm; a partitioning member for partitioning the liquid filled chamber into a first liquid chamber on the vibration isolating base side and a second liquid chamber on the diaphragm side; and an orifice connecting the first liquid chamber and the second liquid chamber so that the first and second liquid chambers can communicate with each other, as disclosed in the following Patent Reference Nos. 1 and 2, for example. In this liquid filled type vibration isolator, a first outer periphery of the diaphragm is bonded to at least an inner periphery of an annular attachment plate by vulcanization, and a second outer periphery of the attachment plate is fixed to an inner circumference of the second attachment member. According to these references, the partitioning member has an annular orifice forming member for forming the orifice, and a rubber wall for closing the inside of the inner circumference of the orifice forming member.

According to the following Patent Reference No. 3, the partitioning member has an elastic partitioning film, an annular orifice forming member for accommodating the elastic partitioning film, and first grid member and second grid member for regulating displacement of the elastic partitioning film from both sides of the film surface. The orifice forming member accommodating the elastic partitioning film is sandwiched between a receiving step formed on the vibration isolating base and a ring-disk-shaped metal pinching member (referred to as “partitioning plate lower metal fitting”) to be fixed therebetween. The outer periphery of the pinching member is caulked to the inner circumference of the second attachment member. The pinching member in the pinching condition is superposed on a metal attachment plate on the outer periphery of the diaphragm from above, and the attachment plate is superposed on a flange disposed at the upper end of a cup-shaped bottom metal fitting of the second attachment member from above.

According to the liquid filled vibration isolator disclosed in Patent Reference No. 3, at the time of generation of low-frequency vibration having large amplitude, liquid flows between the first and second liquid chambers through the orifice to produce liquid. flow effect which decreases the vibration. At the time of generation of high-frequency vibration having small amplitude, the elastic partitioning film reciprocatively deforms to absorb liquid pressure in the first liquid chamber and thereby decreases the vibration. According to the structure disclosed in this reference, impact caused by collision of the elastic partitioning film with the first and second grid members is transmitted to the bottom metal fitting via the pinching member and the attachment plate both made of metal. This impact is further transmitted to the vehicle body, causing abnormal noise in the vehicle cabin.

For overcoming this problem, reduction of the clearance between the elastic partitioning film and the first and second grid members is considered. In this case, however, the dynamic spring constant in the high frequency range becomes large, and thus desired vibration isolating capability is difficult to be achieved.

According to this type of liquid filled type vibration isolator, therefore, it is needed that the reciprocatively deformable component provided on the partitioning member is easily displaced for high-frequency vibration having small amplitude, and that the displacement of the reciprocatively deformable component is regulated as much as possible for input of vibration having large amplitude so as to obtain the liquid flow effect produced by the orifice. In addition, it is desired that the impact produced by the collision of the reciprocatively deformable component with the members for regulating the displacement of the reciprocatively deformable component is not transmitted to the vehicle cabin. However, these requirements are not sufficiently satisfied by the known liquid filled type vibration isolators.

According to the following Patent Reference No. 4, a rubber wall is provided on an opening formed in the central area of the partitioning member main body. A pair of displacement regulating members for regulating the elastic deformation of the rubber wall are provided on both sides of the film surface of the rubber wall. The pair of the displacement regulating members are connected with each other via a connecting member penetrating through the central area of the rubber wall. According to this reference, since the rubber wall is attached to the opening formed in the central area of the partitioning member main body on the lower surface of which the diaphragm is overlapped, the lower displacement regulating member of the two displacement regulating members is disposed facing not the liquid chamber but an air chamber. In this structure, therefore, vibration of the rubber wall caused by liquid pressure fluctuations in the first liquid chamber positioned on the upper side is not sufficiently transmitted to the second liquid chamber positioned on the lower side, that is, the vibration of the first liquid chamber is only released to the air chamber. Thus, the spring constant at the time of high-frequency vibration is not sufficiently decreased.

According to the structure disclosed in Patent Reference No. 4, the displacement of the rubber wall caused at the time of input of vibration having large amplitude is regulated by the pair of the displacement regulating members which extend over the opening edge of the partitioning member main body to the outside. Thus, at the time of input of vibration having large amplitude, the displacement regulating members contact the partitioning member main body in the axial direction via the edge of the rubber wall, and the rubber is compressed between the displacement regulating members and the partitioning member main body. As a result, the spring constant rapidly increases. In this case, the input given from the displacement regulating members to the partitioning member main body is large, which possibly results in generation of abnormal noise.

The following Patent Reference No. 5 discloses a “releasing device assembly” including a pair of upper and lower plate members and a connecting member for connecting these plate members provided in the central area of the partitioning member. However, the partitioning member equipped with the releasing device assembly does not have the rubber wall. More specifically, the releasing device assembly is disposed on the opening in the central area of the partitioning member made of rigid material such that the releasing device can freely slide, and the structure of the pair of the partitioning plates provided in the central area of the rubber wall for pinching the rubber wall in the axial direction is not disclosed in this reference.

An automobile engine mount disclosed in the following Patent Reference No. 6 includes a rubber bellows which has two convexes and constitutes an air spring. An intermediate ring for adding weight is supported between the convexes. The inside of the rubber bellows is divided into two chambers by a pair of fixing plates which pinch an inward flange of the intermediate ring. However, the rubber portion pinched by the pair of the fixing plates does not correspond to the rubber wall closing the inside of the inner circumferential surface of the ring-shaped component. Thus, this structure does not decrease high-frequency vibration by the reciprocatative deformation of the rubber portion. Accordingly, the structure of the pair of the partitioning plates provided in the central area of the rubber wall in the axial direction for pinching the rubber wall is not disclosed in this reference similarly to the above case.

Patent Reference No. 1: JP-A-2002-310224

Patent Reference No. 2: JP-A-2001-027278

Patent Reference No. 3: JP-A-2004-316895

Patent Reference No. 4: GB 2,332,498 A

Patent Reference No. 5: JP-UM-A-03-062244

Patent Reference No. 6: JP-A-57-26015

### DISCLOSURE OF THE INVENTION

### Problems that the Invention is to Solve

The invention has been developed to solve the above problems. It is an object of the invention to provide a liquid filled type vibration isolator which can reduce generation of abnormal noise without decreasing vibration isolating capability.

### Solution Means of the Problems

A liquid filled type vibration isolator according to the invention includes: a first attachment member; a cylindrical second attachment member; a vibration isolating base made of rubber-like elastic material for connecting the first attachment member and the second attachment member; a diaphragm formed by a rubber film and attached to the second attachment member to form a liquid filled chamber between the diaphragm and the vibration isolating base; a partitioning member for partitioning the liquid filled chamber into a first liquid chamber on the vibration isolating base side and a second liquid chamber on the diaphragm side; and an orifice for connecting the first liquid chamber and the second liquid chamber such that these liquid chambers can communicate with each other.

The partitioning member includes:

an annular orifice forming member provided inside a circumferential wall of the second attachment member to form the orifice;

a rubber wall whose outer circumference is bonded to an inner circumferential surface of the orifice forming member by vulcanization to close the inside of the inner circumferential surface of the orifice forming member; and

a pair of partitioning plates connected with each other via a connecting member penetrating through a central area of the rubber wall in the radial direction, between which plates the rubber wall is sandwiched in an axial direction of the rubber wall.

One of the pair of the partitioning plates constitutes a part of a chamber wall of the first liquid chamber and the other partitioning plate constitutes a part of a chamber wall of the second liquid chamber. Displacements of the pair of the partitioning plates in an axial direction of the orifice forming member are regulated by the rubber wall.

According to this structure, the displacements of the pair of the partitioning plates are regulated by the rubber wall provided inside the inner circumferential surface of the orifice forming member. Thus, the vibration isolator offers desired vibration isolating capability for absorbing high-frequency vibration while regulating displacements of the pair of the partitioning plates caused by vibration having large amplitude. More specifically, at the time of vibration having large amplitude, liquid flows between the first liquid chamber and the second liquid chamber through the orifice to produce liquid flow effect which decreases the vibration. At the time of high-frequency vibration having small amplitude, the pair of the partitioning plates reciprocate as one body and absorb liquid pressure in the first liquid chamber to decrease the vibration. Since the pair of the partitioning plates face the first liquid chamber and the second liquid chamber, the liquid pressure fluctuations in the first liquid chamber can be adequately transmitted to the second liquid chamber. Thus, both the first liquid chamber and the second liquid chamber can produce resonance effect, resulting in improvement of vibration reduction effect.

According to this structure, the rubber wall is interposed between the pair of the partitioning plates and other hard components such as the orifice forming member. Thus, impact caused by collision of the pair of the partitioning plates with the rubber wall at the time of vibration having large amplitude or high-frequency vibration is absorbed by the rubber wall. As a result, the impact is not easily transmitted to the second attachment member and the first attachment member.

According to an example of the liquid filled type vibration isolator of the invention, an attachment hole through which the connecting member penetrates is formed in the central area of the rubber wall. Annular convexes project from the front and back of the rubber wall around the attachment hole to the outside in the axial direction. The annular convexes engage with annular concaves each of which is formed on the corresponding plate of the two partitioning plates. In this case, the rubber wall and the partitioning plates are positioned in the radial direction. In addition, even when the attachment hole is subject to expansion at the time of input of vibration having large amplitude, separation of the partition plates from the rubber wall is prevented by the engagement between the convexes and the concaves on the partitioning plates.

According to an example of the liquid filled type vibration isolator of the invention, the respective ends of the outer peripheries of the partitioning plates are located inside the outer circumferential edge of the rubber wall and the inner circumferential surface of the orifice forming member in the radial direction. In this case, the spring constant slowly increases at the time of input of vibration having large amplitude, thereby reducing generation of abnormal noise. Since the force received by the partitioning plates is transmitted to the orifice forming member via the rubber wall only as a force substantially in the shearing direction, the orifice forming member receives only small force.

According to an example of the liquid filled type vibration isolator of the invention, each of the partitioning plates has a first partitioning plate portion disposed at the center in the radial direction for connection, a second partitioning plate portion disposed outside the first partitioning plate portion in the radial direction for holding the rubber wall, and a third partitioning plate portion disposed outside the second partitioning plate portion in the radial direction at a position opposed to the rubber wall with a clearance between the third partitioning plate portion and the rubber wall. In this case, the vibration isolating capability is adjustable by controlling the clearance.

According to an example of the liquid filled type vibration isolator of the invention, a plate surface of the third partitioning plate portion facing the rubber wall and a wall surface of the rubber wall opposed to the plate surface have tapered surfaces which extend outward in the radial direction while inclining outward in the axial direction of the rubber wall. The clearance between the third partitioning plate portion and the rubber wall gradually expands toward the outside in the radial direction of the orifice forming member. In this case, the displacements of the plate surfaces of the partitioning plates are regulated by the wall surfaces of the rubber wall softly, and thus collision is not easily caused.

According to an example of the liquid filled type vibration isolator of the invention, the connecting member has a convex formed on the first partitioning plate portion of one of the partitioning plates. An attachment hole through which the convex is press-fitted penetrates through the central area of the rubber wall. The distal end of the convex engages with an engaging portion formed on the first partitioning plate portion of the other partitioning plate to be fixed thereto. In this case, the pair of the partitioning plates can be securely connected.

According to an example of the liquid filled type vibration isolator of the invention, the external shape of the one partitioning plate facing the first liquid chamber is larger than that of the other partitioning plate facing the second liquid chamber. In this case, the following advantages are offered. Generally, the force applied to the pair of the partitioning plates is larger during pressure-applied displacement in the first liquid chamber than during negative pressure displacement. Since the external shape is determined as above, displacement regulation effect can be increased according to the degree of the force applied to the partitioning plates. Therefore, the liquid flow effect produced by the orifice at the time of input of vibration having large amplitude can be more effectively increased.

According to an example of the liquid filled type vibration isolator of the invention, a first outer periphery of the diaphragm is bonded at least to an inner periphery of an annular attachment plate by vulcanization, and a second outer periphery of the attachment plate is fixed to an inner circumferential surface of the second attachment member. A cylindrical standing wall extending upward in an inner axial direction of the orifice forming member is provided on the inner periphery of the attachment plate. The first outer periphery of the diaphragm is bonded to the inner periphery of the attachment plate by vulcanization in such a condition as to cover the standing wall. The standing wall engages with the inner surface of one end of the orifice forming member. The orifice forming member is sandwiched between an attachment plate portion of the standing wall at the root and a receiving step formed on the vibration isolating base to be fixed therebetween. A rubber portion of the first outer periphery of the diaphragm is interposed between the attachment plate portion and the one end of the orifice forming member and between an outer circumferential surface of the standing wall of the attachment plate and an inner circumferential surface of the one end of the orifice forming member. In this case, the following advantages are offered.

Since the cylindrical standing wall engages with the inner surface of the one end of the orifice forming member, the orifice forming member is positioned in the radial direction of the orifice forming member. Since the rubber portion of the first outer periphery of the diaphragm is interposed between the attachment plate portion and the one end of the orifice forming member and between the outer circumferential surface of the standing wall of the attachment plate and the inner circumferential surface of the one end of the orifice forming member, the impact is absorbed by the rubber portion even when the impact is transmitted to the orifice forming member. Thus, transmission of the impact to the vehicle body via the attachment plate and the second attachment member is prevented. Furthermore, a ring-disk-shaped metal pinching member for pinching and fixing the orifice forming member together with the receiving step formed on the vibration isolating base can be eliminated, resulting in reduction of number of components and weight and simplification of the structure.

### Advantage of the Invention

According to the invention, a liquid filled type vibration isolator which reduces generation of abnormal noise without lowering vibration isolating capability is provided.

### BRIEF DESCRIPTION OF THE DRAWINGS

FIG. 1 is a vertical cross-sectional view of a liquid filled type vibration isolator in an embodiment.

FIG. 2 is a vertical cross-sectional view of a partitioning member and a diaphragm of the vibration isolator.

FIG. 3 is a vertical cross-sectional view of the partitioning member.

FIG. 4 is a vertical cross-sectional view of the diaphragm.

FIG. 5 is a vertical cross-sectional view of a connection structure for connecting the partitioning member and the diaphragm.

FIG. 6 is a plan view of the partitioning member.

FIG. 7 is a view in a direction indicated by an arrow F in FIG. 6.

FIG. 8 is a vertical cross-sectional view of the disassembled partitioning member.

### BEST MODE FOR CARRYING OUT THE INVENTION

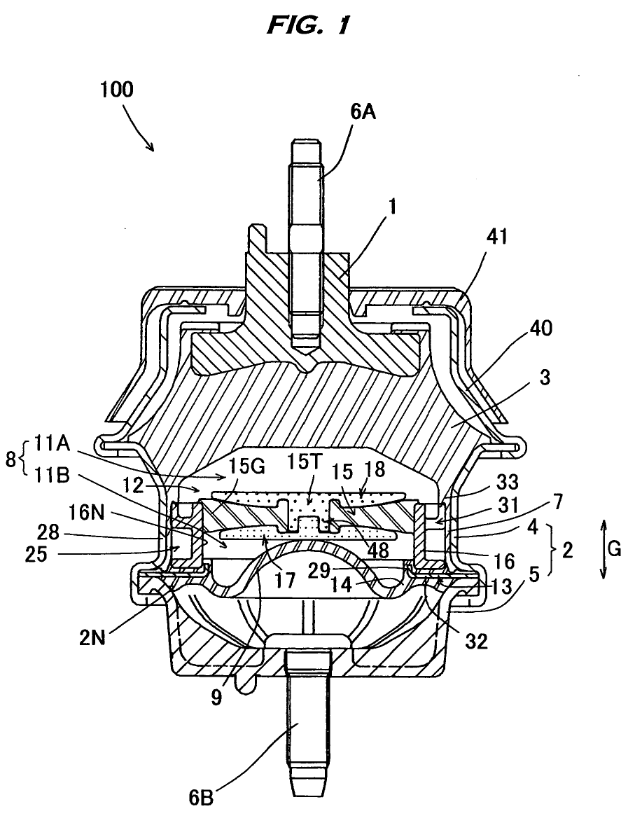

An embodiment according to the invention is hereinafter described with reference to the drawings. FIG. 1 is a vertical cross-sectional view of a liquid filled type vibration isolator 100 in this embodiment. The vibration isolator 100 includes a first attachment metal fitting 1 attached to an automobile engine, a second cylindrical attachment metal fitting 2 attached to a body frame positioned below the engine, a vibration isolating base 3 made of rubber-like elastic material for connecting the first and second fittings 1 and 2, a stopper metal fitting 40, and a rubber cover 41 for covering the stopper metal fitting 40.

The first attachment metal fitting 1 has a first attachment bolt 6A projecting upward. The second attachment metal fitting 2 is constituted by a cylindrical metal fitting 4 on which the vibration isolating base 3 is formed by vulcanization, and a cup-shaped bottom metal fitting 5. A second attachment bolt 6B projecting downward is provided in the central area of the bottom metal fitting 5. The vibration isolating base 3 has a truncated cone shape. The upper end surface of the base 3 is bonded to the first attachment metal fitting 1 by vulcanization, and the lower end portion of the base 3 is bonded to an upper end opening of the cylindrical metal fitting 4 by vulcanization. The upper end opening of the fitting 4 extends upward while gradually expanding. A rubber-film-shaped seal wall 7 for covering the inner circumferential surface of the cylindrical metal fitting 4 is provided at the lower end of the vibration isolating base 3.

A partially spherical diaphragm 9 is attached to the second attachment metal fitting 2. The diaphragm 9 is formed by a rubber film and constitutes a liquid filled chamber 8 between the lower surface of the vibration isolating base 3 and the diaphragm 9. The liquid filled chamber 8 is filled with liquid. The diaphragm 9 is covered by the bottom metal fitting 5. A partitioning member 12 for partitioning the liquid filled chamber 8 into a first liquid chamber 11A on the vibration isolating base 3 side and a second liquid chamber 11B on the diaphragm 9 side is equipped. An orifice 25 is formed so that the first liquid chamber 11A and the second liquid chamber 11B can communicate with each other.

The partitioning member 12 has: an annular orifice forming member 16 provided inside a cylindrical circumferential wall 28 of the second attachment metal fitting 2; a rubber wall 15 whose outer circumference 15G is bonded to an inner circumferential surface 16N of the orifice forming member 16 by vulcanization to close the inside of the inner circumferential surface 16N; and a pair of upper and lower partitioning plates 17 and 18 connected with each other via a connecting member (corresponding to a first convex 48 to be described later) penetrating through a central area 15T of the rubber wall 15 in the radial direction. The rubber wall 15 is sandwiched between the pair of the partitioning plates 17 and 18 in an axial direction G of the rubber wall 15.

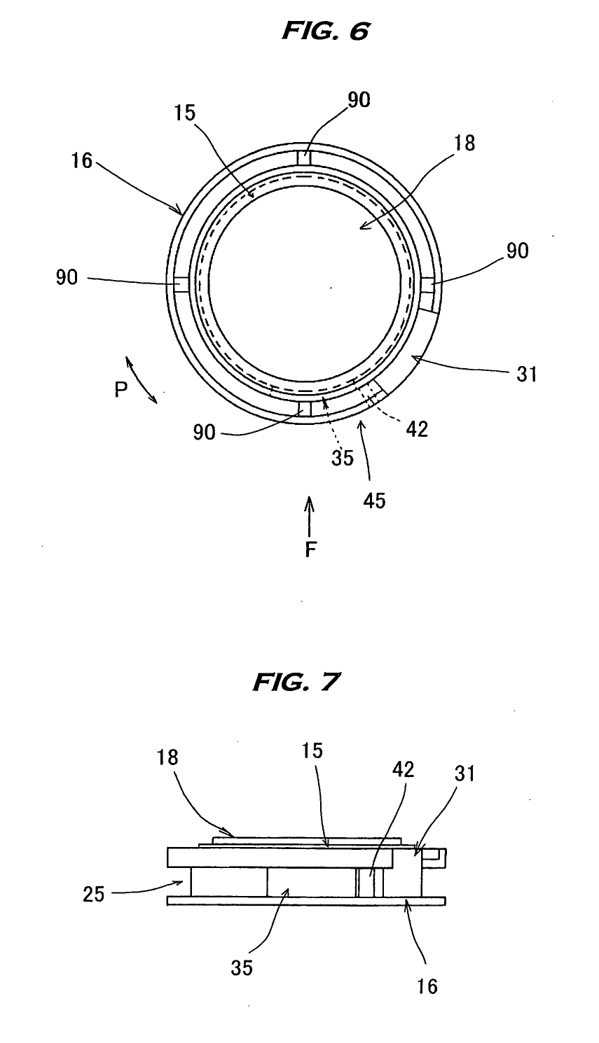

The orifice forming member 16 forms the orifice 25 between the orifice forming member 16 and the circumferential wall 28 of the second attachment metal fitting 2, more specifically, between the orifice forming member 16 and the seal wall 7 covering the inner circumferential surface of the circumferential wall 28, and engages with the inner circumference of the circumferential wall 28. Thus, the orifice 25 is formed along the circumference of the orifice forming member 16 (see FIGS. 6 and 7) in a circumferential direction P. The orifice forming member 16 has a plurality of ribs 90.

The rubber wall 15 is a disk-shaped component. The outer circumference 15G of the rubber wall 15 is bonded to an inner circumferential surface 16N of a cylindrical main body 16H of the orifice forming member 16 by vulcanization (see FIG. 3).

The partitioning plate 18 of the two partitioning plates 17 and 18 constitutes a part of the chamber wall of the first liquid chamber 11A (that is, disposed facing the first liquid chamber 11A), and the other partitioning plate 17 constitutes a part of the chamber wall of the second liquid chamber 11B (that is, disposed facing the second liquid chamber 11B). The displacements of the pair of the partitioning plates 17 and 18 are regulated by the rubber wall 15 in an axial direction G of the orifice forming member 16 (identical to the axial direction G of the rubber wall 15).

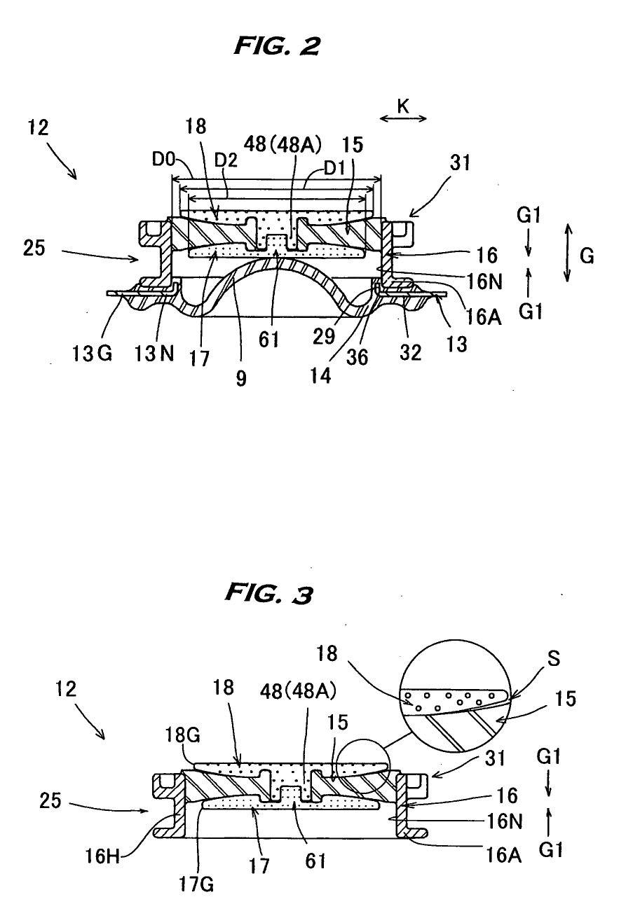

The ends of outer circumferential edges 17G and 18G of the partitioning plates 17 and 18 are positioned inside the outer circumferential edge of the rubber wall 15 and the inner circumferential surface 16N of the orifice forming member 16 in the radial direction (see FIG. 3). In this embodiment, as illustrated in FIG. 2, the position of the outer circumferential edge of the rubber wall 15 coincides with the position of the inner circumferential surface 16N of the orifice forming member 16 as the position of the junction surface of these components in a radial direction K of the orifice forming member 16. Thus, outside diameters D1 and D2 of the partitioning plates 17 and 18 are smaller than a diameter D0 of the junction surface (that is, the inner circumferential surface 16N), and the external shapes of the partitioning plates 17 and 18 are smaller than the external shape of the rubber wall 15 in the plan view (see FIG. 6). In this embodiment, the external shape of the partitioning plate 18 facing the first liquid chamber 11A is larger than the external shape of the partitioning wall 17 facing the second liquid chamber 11B (outside diameter D1 of partitioning plate 18>outside diameter D2 of partitioning plate 17).

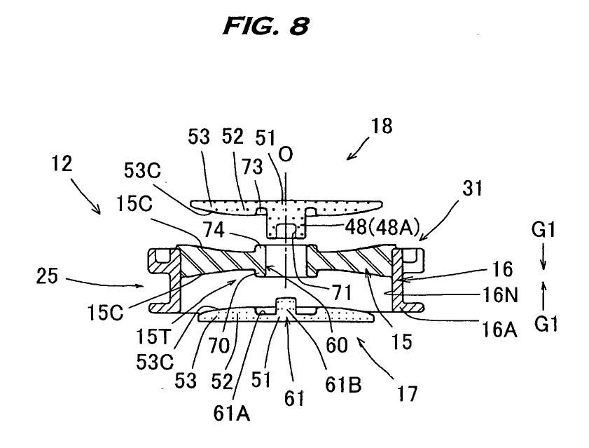

As illustrated in FIG. 8, each of the partitioning plates 17 and 18 has a first partitioning plate portion 51 provided at the center in the radial direction for connection, a second partitioning plate portion 52 positioned outside the first partitioning plate portion 51 in the radial direction to hold the rubber wall 15, and a third partitioning plate portion 53 positioned outside the second partitioning plate portion 52 in the radial direction at a position opposed to the rubber wall 15 with a clearance S between the third partitioning plate portion 53 and the rubber wall 15 (see FIG. 3). A plate surface 53C of the third partitioning plate portion 53 facing the rubber wall 15 and a wall surface 15C of the rubber wall 15 opposed to the plate surface 53C have tapered surfaces which extend outward in the radial direction while inclining outward in the axial direction of the rubber wall 15, and the clearance S gradually expands toward the outside in the radial direction of the orifice forming member 16. By this arrangement, the thickness of the rubber wall 15 gradually increases toward the outside in the radial direction. The tapered surfaces have smoothly curved shapes in the vertical cross section of the partitioning member 12. An axial center O of the rubber wall 15 coincides with an axial center O of the partitioning plates 17 and 18.

The connecting member has the cylindrical first convex 48 projecting from the first partitioning plate portion 51 of the partitioning plate 18. An attachment hole 60 through which the first convex 48 is press-fitted penetrates through an central area 15T of the rubber wall 15. An annular distal end 48A of the first convex 48 engages with an engaging portion 61 formed on the first partitioning plate portion 51 of the partitioning plate 17 to be fixed thereto. The engaging portion 61 has an annular first groove 61A and a second convex 61B projecting from a position inside the first groove 61A in the radial direction. The first convex 48 is press-fitted through the attachment hole 60. An annular third convex 70 projecting from the inner circumferential edge of the rubber wall 15 to one side in the axial direction engages with the inner surface of the first groove 61A. The second convex 61B engages with the inner surface of a hollow 71 at the distal end 48A of the first convex 48. An annular second groove 73 surrounding the first convex 48 is formed at the base end of the first convex 48. An annular fourth convex 74 projecting from the inner circumferential edge of the rubber wall 15 to the other side in the axial direction engages with the second groove 73.

The annular convexes 70 and 74, which project from the back and front of the rubber wall 15 around the attachment hole 60 to the outside in the axial direction, engage with the annular concave grooves 61A and 73 formed on the pair of the partitioning plates 17 and 18 when the rubber wall 15 and the pair of the partitioning plates 17 and 18 are assembled. The pair of the partitioning plates 17 and 18 are formed by resin material. The first convex 48 and the engaging portion 61 are fixed to each other by ultrasonic welding.

As illustrated in FIGS. 6 and 7, a vertical wall 42 for forming an end 45 of the orifice 25 in the circumferential direction P is provided on the orifice forming member 16. The orifice forming member 16 has a first opening 31 for connecting the orifice 25 and the first liquid chamber 11A, and a second opening 35 for connecting the orifice 25 and the second liquid chamber 11B.

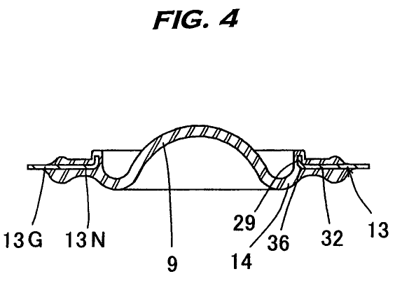

As illustrated in FIGS. 1 and 4, a first outer periphery 14 of the diaphragm 9 is bonded to an inner circumferential edge 13N of the annular attachment plate 13 by vulcanization, and a second outer periphery 13G of the attachment plate 13 is fixed to an inner circumference 2N of the second attachment metal fitting 2. More specifically, the second outer periphery 13G of the attachment plate 13 and the upper end of the bottom metal fitting 5 are covered by the lower end of the cylindrical metal fitting 4, and these three portions are caulked into one body.

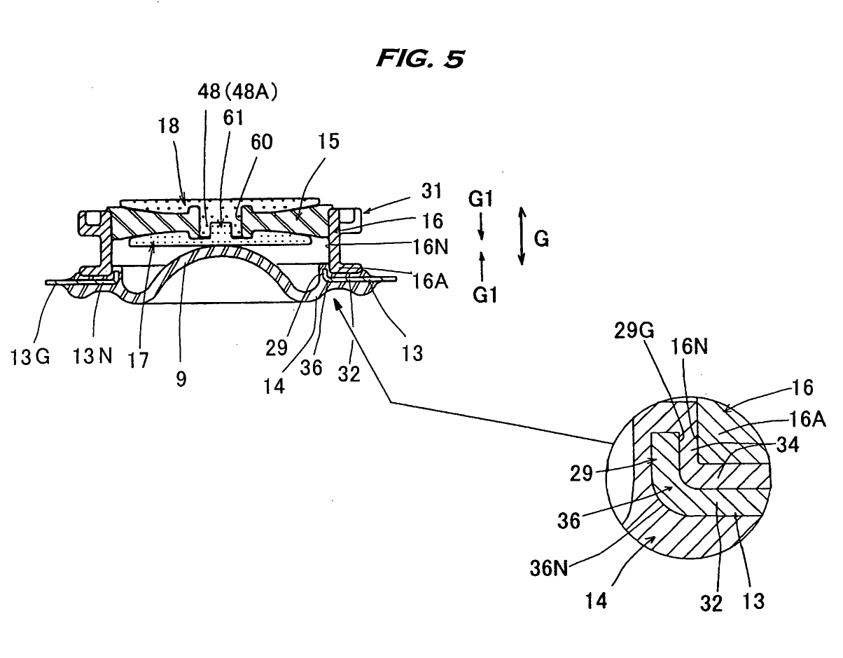

As illustrated in FIG. 5, a cylindrical standing wall 29 which extends upward in an inner axial direction G1 of the orifice forming member 16 is provided on an inner periphery 13N of the attachment plate 13. The first outer periphery 14 of the diaphragm 9 is bonded to the inner periphery 13N of the attachment plate 13 by vulcanization in such a condition that the outer periphery 14 covers the standing wall 29. The standing wall 29 engages with the inner surface of one end 16A of the orifice forming member 16. The orifice forming member 16 is sandwiched between an attachment plate portion 32 at the root of the standing wall 29 and a receiving step 33 formed on the vibration isolating base 3 (see FIG. 1) and fixed therebetween. A rubber portion 34 of the first outer periphery 14 of the diaphragm 9 is interposed between the attachment plate portion 32 and the one end 16A of the orifice forming member 16 and between an outer circumferential surface 29G of the standing wall 29 and the inner circumferential surface 16N of the one end 16A of the orifice forming member 16.

The first outer periphery 14 of the diaphragm 9 is bonded to the inner periphery 13N of the attachment plate 13 by vulcanization in such a condition that the first outer periphery 14 covers a convex side surface 36N of a corner 36 formed by the standing wall 29 and the attachment plate portion 32. The convex side surface 36N of the corner 36 has a circular-arc-shaped vertical cross section. The first outer periphery 14 of the diaphragm 9 freely swings upward and downward around the corner 36 having the circular-arc-shaped vertical cross section in accordance with input of vibration.

According to the liquid filled type vibration isolator 100 having this structure in this embodiment, displacements of the pair of the partition plates 17 and 18 are regulated by the rubber wall 15 at the time of generation of low-frequency vibration having large amplitude. As a result, liquid flows between the first liquid chamber 11A and the second liquid chamber 11B through the orifice 25, and the vibration is decreased by liquid flow effect thus produced. Since the external shapes of the partition plates 17 and 18 are smaller than that of the rubber wall 15, a region constituted only by the rubber wall 15 having no rigidity is secured between the inner circumferential surface 16N of the orifice forming member 16 and the partitioning plates 17 and 18. Thus, the force received by the partitioning plates 17 and 18 at the time of input of the vibration having large amplitude is transmitted to the orifice forming member 16 via the rubber wall 15 only as a force substantially in the shearing direction. Therefore, the orifice forming member 16 receives only small force, and the spring constant slowly increases. Moreover, since the thickness of the rubber wall 15 outside the partitioning plates 17 and 18 in the radial direction is large, the rubber wall 15 has excellent capability for regulating displacements of the partitioning plates 17 and 18.

When high-frequency vibration having small amplitude is generated, the displacements of the pair of the partitioning plates 17 and 18 are not regulated by the rubber wall 15. In this case, the partitioning plates 17 and 18 reciprocate as one body. As a result, liquid pressure in the first liquid chamber 11A is absorbed and thereby the vibration is decreased. Since the pair of the partitioning plates 17 and 18 face the first liquid chamber 11A and the second liquid chamber 11B, respectively, the liquid pressure fluctuations in the first liquid chamber 11A can be adequately transmitted to the second liquid chamber 11B. Thus, both the first liquid chamber 11A and the second liquid chamber 11B can produce resonance effect, resulting in improvement of vibration reduction effect.

In this embodiment, the rubber wall 15 is interposed between the pair of the partition plates 17 and 18 and the orifice forming member 16. Thus, the impact produced by the collision of the pair of the partition plates 17 and 18 with the rubber wall 15 at the time of vibration having large amplitude or absorption of high-frequency vibration is absorbed by the rubber wall 15. As a result, the impact is not easily transmitted to the second attachment metal fitting 2 and the first attachment metal fitting 1. Furthermore, the orifice forming member 16 is fixed to the second attachment metal fitting 2 via the seal wall 7, the receiving step 33, and the rubber portion 34 of the diaphragm 9 as elastic members. Thus, even when the impact is transmitted to the orifice forming member 16, the impact is absorbed by these elastic portions without transmission to the vehicle body.

According to this embodiment, therefore, the partition plates 17 and 18 are easily displaced for high-frequency vibration having small amplitude. On the other hand, the displacements of the partition plates 17 and 18 are regulated as much as possible for the input of vibration having large amplitude so that liquid flow effect can be produced by the orifice 25. Moreover, transmission of the impact caused at the time of collision of the partition plates 17 and 18 with the rubber wall 15 to the vehicle cabin can be prevented.

According to this embodiment, the annular convexes 70 and 74 are formed on the back and front surfaces of the rubber wall 15 around the attachment hole 60, and the rubber wall 15 is fixed to the pair of the partitioning plates 17 and 18 under the condition where the convexes 70 and 74 engage with the grooves 61A and 73 of the partitioning plates 17 and 18. Thus, even when the attachment hole 60 of the rubber wall 15 is subject to expansion by excessively large force applied to the partitioning plates 17 and 18 particularly at the time of input of vibration having large amplitude, separation of the partition plates 17 and 18 from the rubber wall 15 is prevented by the engagement between the convexes 70 and 74 and the grooves 61A and 73.

According to this embodiment, the partitioning plate 18 on the first liquid chamber 11A side is larger than the partitioning plate 17 on the second liquid chamber 11B side. Thus, the downward displacement (that is, toward the second liquid chamber 11B) of the pair of the partitioning plates 17 and 18 is more largely regulated than the upward displacement (that is, toward the first liquid chamber 11A). Generally, at the time of input of vibration having large amplitude, the force applied to the pair of the partitioning plates 17 and 18 is larger during pressure-applied displacement in the first liquid chamber 11A in which the partitioning plates 17 and 18 are displaced downward than during negative pressure displacement in which the partitioning plates 17 and 18 are displaced upward. Since the sizes of the partitioning plates 17 and 18 are determined as above, displacement regulation effect can be increased according to the degree of the force applied to the partitioning plates 17 and 18. Therefore, the liquid flow effect produced by the orifice 25 at the time of input of vibration having large amplitude can be more effectively increased.

In the structure having a dedicated pinching member for pinching and fixing the orifice forming member together with the receiving step of the vibration isolating base and an opening formed on the pinching member and open to the second liquid chamber, for example, a time-consuming process for positioning the orifice forming member in the circumferential direction relative to the pinching member is required for the purpose of determining the length of the orifice in the circumferential direction. However, when the vertical wall 42 for forming the end 45 of the orifice 25 in the circumferential direction P and the second opening 35 for connecting the orifice 25 and the second liquid chamber 11B are provided on the orifice forming member 16 as in this embodiment, the length of the orifice 25 in the circumferential direction P can be determined only by the orifice forming member 16. Thus, the necessity for the process for positioning the orifice forming member is eliminated, and thus the work efficiency can be improved.

Moreover, the first outer periphery 14 of the diaphragm 9 is bonded by vulcanization in such a condition to cover the convex side surface 36N of the corner 36 having a circular-arc-shaped vertical cross section on the attachment plate 13. Thus, the first outer periphery 14 of the diaphragm 9 can swing around the corner 36 having the circular-arc-shaped vertical cross section in accordance with input of vibration. Accordingly, the problem that force is concentrated on a part of the first outer periphery 14 of the diaphragm 9 can be avoided, and durability of the diaphragm 9 can be increased.

### DESCRIPTION OF REFERENCE NUMERALS AND SIGNS

1 . . . first attachment member (first attachment metal fitting
2 . . . second attachment member (second attachment metal fitting), 2N . . . inner circumference
3 . . . vibration isolating base
8 . . . liquid filled chamber
9 . . . diaphragm
11A . . . first liquid chamber
11B . . . second liquid chamber
12 . . . partitioning member
13 . . . attachment plate, 13N . . . inner periphery, 13G . . . second outer periphery
14 . . . first outer periphery
15 . . . rubber wall, 15C . . . wall surface, 15G . . . outer circumference, 15T . . . central area in radial direction
16 . . . orifice forming member, 16A . . . one end, 16N . . . inner circumferential surface
17 . . . partitioning plate (other partitioning plate)
18 . . . partitioning plate (one partitioning plate)
25 . . . orifice
28 . . . circumferential wall
29 . . . standing wall, 29G . . . outer circumferential surface
32 . . . attachment plate portion
33 . . . receiving step
34 . . . rubber portion
48 . . . connecting member (convex (first convex)), 48A . . . distal end
51 . . . first partitioning plate portion
52 . . . second partitioning plate portion
53 . . . third partitioning plate portion, 53C . . . plate surface
60 . . . attachment hole
61 . . . engaging portion, 61A . . . first groove (annular concave), 61B . . . second convex
70 . . . third convex (annular convex)
73 . . . second groove (annular concave)
74 . . . fourth convex (annular convex)
100 . . . liquid filled type vibration isolator
G . . . axial direction of orifice forming member (axial direction of rubber wall)
G1 . . . inner axial direction of orifice forming member
K . . . radial direction of orifice forming member
S . . . clearance

1. A liquid filled type vibration isolator, comprising:
a first attachment member;
a cylindrical second attachment member;
a vibration isolating base made of rubber-like elastic material for connecting the first attachment member and the second attachment member;
a diaphragm formed by a rubber film and attached to the second attachment member to form a liquid filled chamber between the diaphragm and the vibration isolating base;
a partitioning member for partitioning the liquid filled chamber into a first liquid chamber on the vibration isolating base side and a second liquid chamber on the diaphragm side; and
an orifice for connecting the first liquid chamber and the second liquid chamber such that these liquid chambers can communicate with each other,
wherein the partitioning member includes
an annular orifice forming member provided inside a circumferential wall of the second attachment member to form the orifice,
a rubber wall whose outer circumference is bonded to an inner circumferential surface of the orifice forming member by vulcanization to close the inside of the inner circumferential surface of the orifice forming member; and
a pair of partitioning plates connected with each other via a connecting member penetrating through a central area of the rubber wall in the radial direction, between which plates the rubber wall is sandwiched in an axial direction of the rubber wall,
one of the pair of the partitioning plates constitutes a part of a chamber wall of the first liquid chamber and the other partitioning plate constitutes a part of a chamber wall of the second liquid chamber, and
displacements of the pair of the partitioning plates in an axial direction of the orifice forming member are regulated by the rubber wall.

2. The liquid filled type vibration isolator according to claim 1, wherein:
an attachment hole through which the connecting member penetrates is formed in the central area of the rubber wall;
annular convexes project from the front and back of the rubber wall around the attachment hole to the outside in the axial direction; and
the annular convexes engage with annular concaves each of which is formed on the corresponding plate of the two partitioning plates.

3. The liquid filled type vibration isolator according to claim 1, wherein the respective ends of the outer peripheries of the partitioning plates are located inside the outer circumferential edge of the rubber wall and the inner circumferential surface of the orifice forming member in the radial direction.

4. The liquid filled type vibration isolator according to claim 1, wherein each of the partitioning plates has a first partitioning plate portion disposed at the center in the radial direction for connection, a second partitioning plate portion disposed outside the first partitioning plate portion in the radial direction for holding the rubber wall, and a third partitioning plate portion disposed outside the second partitioning plate portion in the radial direction at a position opposed to the rubber wall with a clearance between the third partitioning plate portion and the rubber wall.

5. The liquid filled type vibration isolator according to claim 4, wherein:
a plate surface of the third partitioning plate portion facing the rubber wall and a wall surface of the rubber wall opposed to the plate surface have tapered surfaces which extend outward in the radial direction while inclining outward in the axial direction of the rubber wall; and
the clearance between the third partitioning plate portion and the rubber wall gradually expands toward the outside in the radial direction of the orifice forming member.

6. The liquid filled type vibration isolator according to claim 4, wherein:
the connecting member has a convex formed on the first partitioning plate portion of one of the partitioning plates;
an attachment hole through which the convex is press-fitted penetrates through the central area of the rubber wall; and
the distal end of the convex engages with an engaging portion formed on the first partitioning plate portion of the other partitioning plate to be fixed thereto.

7. The liquid filled type vibration isolator according to claim 1, wherein the external shape of the one partitioning plate facing the first liquid chamber is larger than that of the other partitioning plate facing the second liquid chamber.

8. The liquid filled type vibration isolator according to claim 1, wherein:
a first outer periphery of the diaphragm is bonded to at least an inner periphery of an annular attachment plate by vulcanization, and a second outer periphery of the attachment plate is fixed to an inner circumference of the second attachment member;
a cylindrical standing wall extending upward in an inner axial direction of the orifice forming member is provided on the inner periphery of the attachment plate;
the first outer periphery of the diaphragm is bonded to the inner periphery of the attachment plate by vulcanization in such a condition as to cover the standing wall;
the standing wall engages with the inner surface of one end of the orifice forming member;
the orifice forming member is sandwiched between an attachment plate portion at the root of the standing wall and a receiving step formed on the vibration isolating base to be fixed therebetween; and
a rubber portion of the first outer periphery of the diaphragm is interposed between the attachment plate portion and the one end of the orifice forming member and between an outer circumferential surface of the standing wall of the attachment plate and an inner circumferential surface of the one end of the orifice forming member.
